(19) United States
(12) Patent Application Publication
(10) Pub. No.: US 2013/0340217 A1
(43) Pub. Date: Dec. 26, 2013

(54) FIREFIGHTER/RESCUE WORKER UTILITY ANCHOR

(71) Applicant: Abraham Madrigal, Hillsboro, OR (US)

(72) Inventor: Abraham Madrigal, Hillsboro, OR (US)

(21) Appl. No.: 13/925,686

(22) Filed: Jun. 24, 2013

Related U.S. Application Data
(60) Provisional application No. 61/663,351, filed on Jun. 22, 2012.

(51) Int. Cl. A62B 35/00

(52) U.S. Cl. CPC A62B 35/0068
USPC 24/583.1

(57) ABSTRACT

A utility anchor having a retracted configuration and an extended configuration and can operate as a tether or anchor in either configuration. It includes an anchor body having a through hole, a rod slidably disposed in the through hole and having a first end and a second end, a rope connector disposed on the first end of the rod, a stopper disposed on the second end of the rod, and a locking element disposed on the rod. A spring disposed between the rope connector and the anchor body urges the apparatus into the retracted configuration, wherein the longitudinal axis the stopper and the anchor body are generally parallel and the locking element is disposed within the anchor body. When the anchor is in the extended configuration, the longitudinal axe of the stopper and the anchor body are not parallel and the stopper is spaced apart from the anchor body.

### CROSS REFERENCES TO RELATED APPLICATIONS

The instant application claims the benefit of U.S. Provisional Patent Application Ser. No. (61/663,351) filed Jun. 22, 2012 (Jun. 22, 2012).

### SEQUENCE LISTING

Not applicable.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

1. Field of the Invention

The present invention relates generally to equipment for firefighters and search and rescue personnel, and more particularly rope anchors, and still more particularly to a utility anchor for use in bailout operations and as a tether for search operations in enclosed spaces with reduced visibility.

2. Background Discussion

Firefighters and other rescue workers occasionally encounter life-threatening situations caused by entrapment in a burning building. When rapid egress or escape is necessary, and when the building is a multistory building, it is common for firefighters to use a rope in connection with an emergency climbing harness to rappel to a safe level or to the ground. When the building is a single story structure, it is common for the firefighter to use a tether and guide rope so as to eliminate the possibility of becoming disoriented and confused about an egress route, particularly when search operations involve multiple changes in direction. In any event, an anchoring device of some kind is used in conjunction with rope, and success in using such an anchoring device depends on a strong tie off point and a reliable anchor. The present invention is a novel anchor adapted for these purposes.

Anchoring devices are well known. For over 100 years steel pitons and rock bolts have been used as anchoring devices in rock climbing. The art is evolving, however, and in recent years climbing enthusiasts have shifted to the use of alternative anchoring devices because of the adverse environment impact of pitons and bolts, including scarring and damage to rock faces, and because of the difficulty of removing pitons and bolts tightly driven into rock. Accordingly, a majority of rock climbers currently endeavor to make “clean climbs” by using chocks, spring-loaded cam devices, or others kinds of removable and expansible anchors.

Even so, pitons retain several advantages over the more environmentally friendly devices, most notably including the simplicity of the device itself, the lightweight nature of the device, the rapidity and simplicity of placement, and the support provided for pulls from multiple directions. In the environment in which firefighters and rescue workers work, however, more adaptable, more versatile devices are called for, devices that take advantage of the kinds of structures found in buildings and that might provide a suitably robust anchor point.

Exemplary devices that show the evolution of anchoring devices from pitons and bolts include the rotatable cam-type chock disclosed in U.S. Pat. No. 4,184,657, to Jardine, which is intended for use in relatively wide cracks. Another reference, that of U.S. Pat. No. 4,572,464 to Phillips, teaches a flexible expansible head-type device. The apparatus employs two dovetailed wedge-type heads attached to flexible wire strands which are used to assist in the insertion of the heads into rock cracks and crannies.

Other representative art includes U.S. Pat. No. 6,505,799, to Bercaw, et al, which shows an ice screw that includes a banger coupled to a tubular shank with a screw thread. The tubular shank includes an ice engaging portion configured to be inserted into ice, a tip, and a head portion. The ice engaging portion includes a reverse taper along its length.

U.S. Pat. No. 4,715,568, to Best, Jr, discloses a wedge plate with a flat rock-engaging surface and a friction surface converging with the rock-engaging surface to define a thick end portion of the wedge plate. A flexible tube or frame is secured to and extends from the thick end portion. A flexible wire extends through the flexible tube and a climbing rope is connected to the wire.

U.S. Pat. No. 4,643,378, to Guthrie, et al, shows a self-wedging, variable thickness climbing aid for rock climbing that includes a wedge-shaped chock to which an anchor cable is affixed with that cable extending from the thin end of the chock with an anchor loop on that end. A roller is attached adjacent one of the broad faces of the chock by means of springs between the ends of the roller and the adjacent sides of the chock. A release cable is attached to each end of the roller for the user to draw the roller down the face of the chock to thin the overall device to permit its insertion or removal from a crack in the rock.

U.S. Pat. No. 5,484,132, to George, et al, discloses an expansible head climbing chock having a three-part expansible head with an arcuate outer circumference and teeth extending around the circumference of both the wedge-type expansible head pieces and the inner end of a rigid body through which the safety rope or cable passes to the largest head piece. The expansible head safety chock is designed to be used in drilled holes in rock faces from which it can be removed. Other notable art includes: U.S. Pat. Nos. 4,770,376 and 4,884,931.

The foregoing patents and background discussion reflect the current state of the art of which the present inventor is aware. However, none of the above-indicated art discloses, teaches, suggests, shows, or otherwise renders obvious, either singly or when considered in combination with other art, the invention described and claimed herein. In particular, none of the prior art devices shows a utility anchor suitable for use a door chock or search line anchor, change of direction anchor, or a bailout device to provide an anchor point for a line used in a belay/rappelling maneuver. The present invention addresses the existing need for such a device.

### SUMMARY OF THE INVENTION

The present invention is a utility anchor for multiple firefighter and rescue personnel operations. It can be used as a belay/rappelling anchor for rapid egress and bailout procedures, a rope tether for search lines, a change of direction anchor, and the like. It has a retracted and an extended configuration, and includes an anchor body with front, back, top, bottom, right and left sides. The anchor has a generally triangular or wedge shape when viewed from either of the front or back sides, though in a preferred embodiment, the wedge is not purely triangular, but includes truncated corners, thereby forming short sides. A through hole disposed from the top to the bottom side. A rod is slidably disposed in the through hole and includes a rope connector (preferably a ring or an eye) on its first (lower) end and a stopper on its second (upper) end. A pin or opposing pins are disposed on the rod below the stopper spaced apart from the stopper. A disc-type lower collar is preferably disposed immediately above the rope connector, and a helical compression spring is disposed around a portion of the rod shaft immediately above the lower collar and between the lower collar and the bottom side of the anchor body. This urges the rod toward the retracted configuration. When the apparatus is in the retracted configuration, the pins nest within the channels cut alongside the through hole and the stopper is generally approximated to the anchor body. When the apparatus is in the extended configuration, the pins rest on the top side of the anchor body. This extended configuration is achieved by pushing the rod sufficiently upwardly and turning it so that the longitudinal axis of the stopper is out of alignment with the longitudinal axis of the anchor body and continuing to turn it until it is generally normal to the longitudinal axis of the anchor body, wherein when the longitudinal axis of the stopper is generally normal to the longitudinal axis of the anchor body, the pins nest in recesses disposed in the top of the anchor body.

### BRIEF DESCRIPTION OF SEVERAL VIEWS OF THE DRAWINGS

FIG. 1A is an upper perspective view showing the utility anchor of the present invention clipped to a carabiner, wherein the anchor body is viewed from a side and a stopper or stopper element extending from the anchor body is shown with its longitudinal axis oriented generally perpendicular to the longitudinal axis of the anchor body;

FIG. 1B is the same view showing the anchor body rotated in relation to the stopper, such the stopper is generally perpendicular to the transverse axis of the anchor body (i.e., the longitudinal axes of the stopper and the anchor body are aligned) and the eye portion of the spring loaded rod is fully extended downward;

FIG. 2A is an upper perspective view showing placement of the utility anchor into the space between a door hinge stile and a door jamb, with the stopper element generally parallel with the door jamb and the longitudinal axis of the anchor body generally perpendicular with the door jamb;

FIG. 2B is the same view showing the stopper element turned generally perpendicular to the door jamb;

FIGS. 3A through 3C are top plan views showing the insertion and placement procedure for installing the utility anchor between a hinge stile and door jamb of a door;

FIG. 4A is a front view in elevation of the utility anchor of the present invention;

FIG. 4B is a cross-sectional side view in elevation, with the stopper element removed, taken along section line 4B-4B of FIG. 4A;

FIG. 4C is a cross-sectional top plan view thereof, taken along section line 4C-4C of FIG. 4A;

FIG. 4D is a cross-sectional side view in elevation thereof, taken along section line 4D-4D of FIG. 4C;

FIG. 4E is a side view in elevation showing the spring-loaded rod fully extended upward and the spring in the compressed position;

FIGS. 5A through 5C are schematic side views in elevation showing installation and placement of the utility anchor beneath a shut door for setting an anchor point.

### DETAILED DESCRIPTION OF THE INVENTION

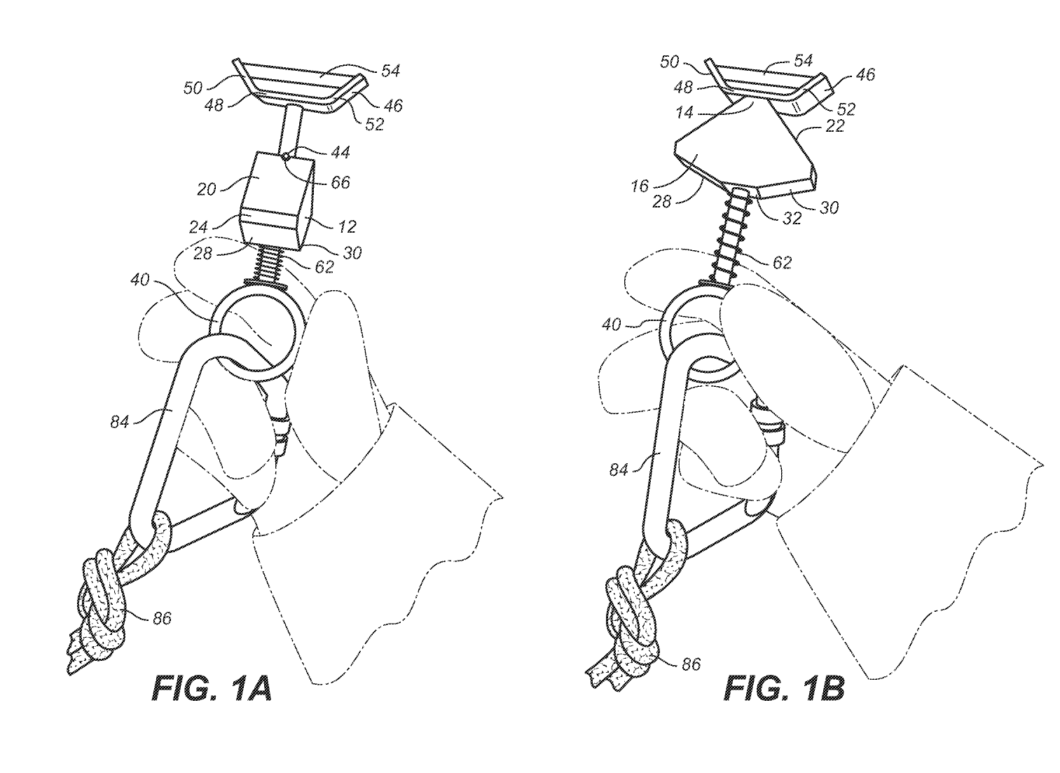

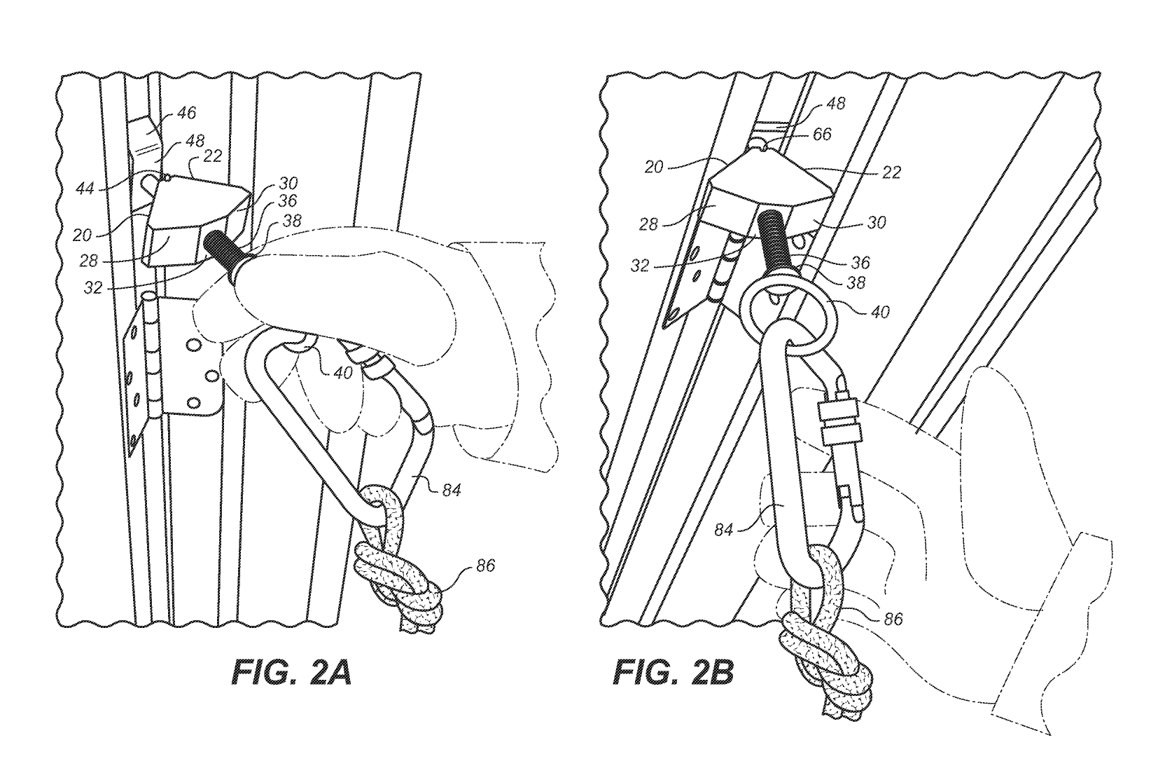

Referring now to FIGS. 1 through 5C, wherein like numbers refer to identical elements in the various views, the present invention is an anchor system for use as a door chock, a search line anchor, a change of direction anchor, and a bailout device.

The utility anchor of the present invention, 10, includes a block fabricated of lightweight, durable metal, such as aluminum, or more preferably an aluminum alloy comprising aluminum and a lightweight refractory metal such as titanium or vanadium. Other suitable materials include glass reinforced polymeric composites.

The anchor includes an anchor body 12 having a generally wedge or triangular shape. In a preferred embodiment, the anchor has the shape of an asymmetrical octagon (i.e., a wedge with major truncated tip, two minor truncated tips, and two sloping shoulders) when viewed in cross section or from the generally planar front and back sides (i.e., those with the greatest surface area). The anchor body 12 includes a top (the major truncated tip referred to above) 14, a generally planar front and back, 16, 18, respectively, right and left upper angled sides, 20, 22, respectively, right and left vertical sides (the two minor truncated tips referred to above), 24, 26, respectively, right and left lower angled sides (the sloping shoulders referred to above) 28, 30, respectively, and a generally planar bottom 32. This geometry makes the anchor body 12 suitable for use as a wedge.

The anchor body 12 is drilled from top to bottom with a through hole 34 in which a rod 36 is passed. The rod 34 includes an integral or welded lower collar 38 and a rope connector, such as a ring or an eye 40, at a first end 42, and an integral upper pin or set of pins 44 spaced apart from a welded or integral stopper 46 at a second end 43, the stopper 46 including a base bar 48, two angled arms 50, 52, and a reinforcement cross bar 54. The stopper 46 has a width 56 substantially the same as, or slightly smaller than, the width 58 of the anchor body 12.

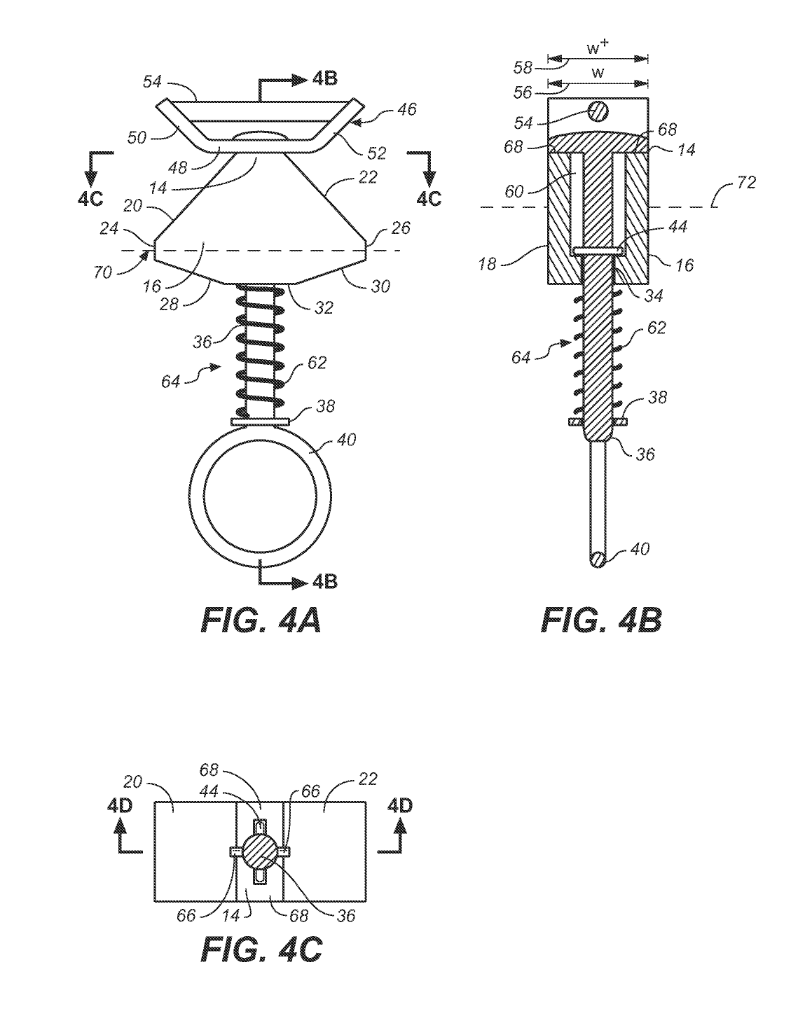

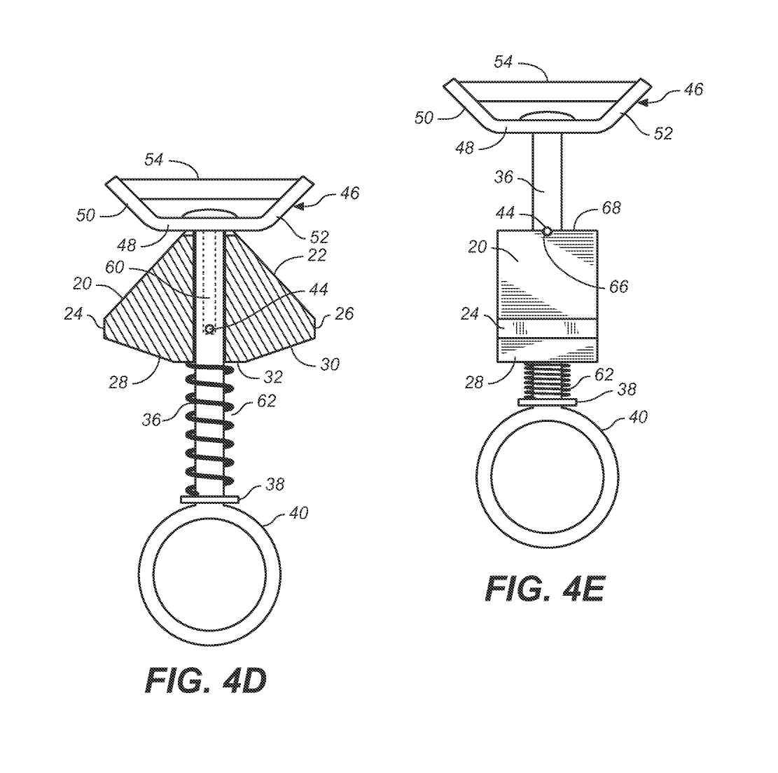

The upper pin or set of pins 44 extend from rod 36 to have a total end-to-end length slightly smaller than that of the width of the stopper 46 and the anchor body 12; moreover, the anchor body 12 includes opposing channels or recesses 60, cut alongside a portion of the through hole 34 such that when the rod 36 is pulled outwardly from the bottom of the anchor body, the pins nest in the channels 60 (see FIGS. 4B and 4E).

A helical compression spring 62 or other means for urging the rod in the direction of the ring 40 is disposed around a portion 64 of the rod shaft immediately above and between the lower collar 38 and the anchor body 12, making the rod spring-loaded relative to the anchor body—viz., the spring urges the eye-containing end away from the anchor body and pulls the stopper toward the anchor body. However, pin(s) 44 disposed through rod 36 below (and spaced apart from) the stopper element rests in the shoulders 68 of the top 14 of the anchor body 12 whenever rod 36 is pushed sufficiently upwardly and turned so that the longitudinal axis 70 of the anchor body 12, which parallels that of the stopper 46, is out of alignment with the transverse axis 72 of the anchor body 12, which axis corresponds in direction with that of the width dimension of both the anchor body 12 and the stopper 46.

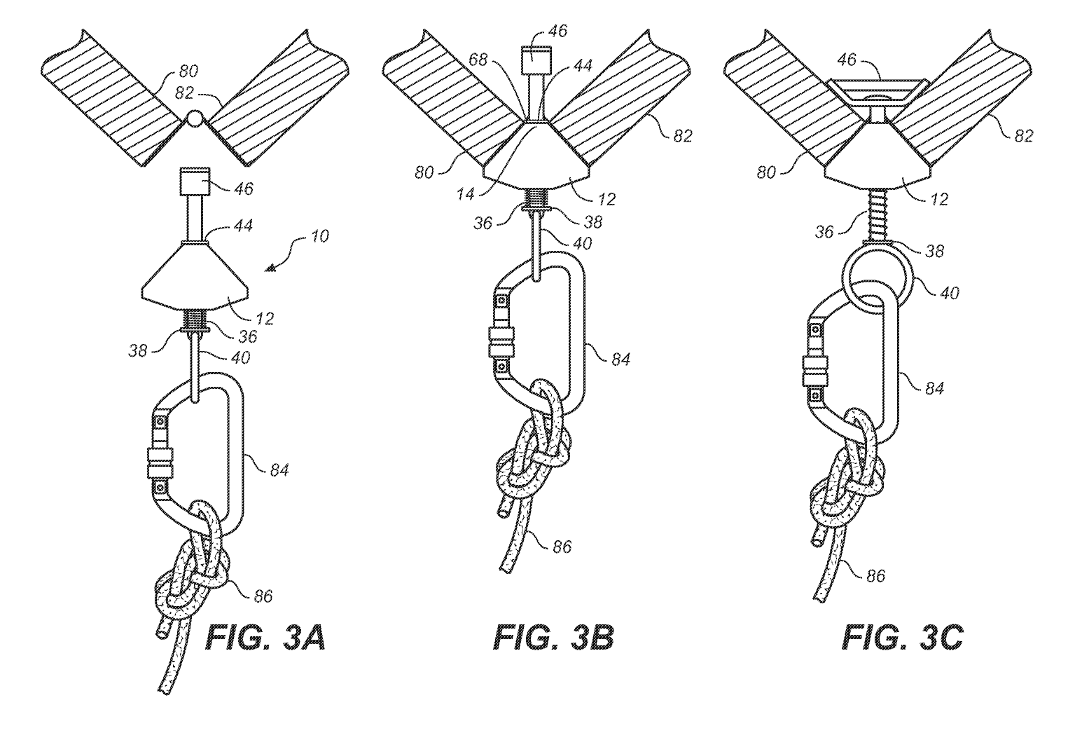

In use, and referring first to FIGS. 1A through 3C, the utility anchor of the present invention can be partially inserted into and/or through structures robust enough to provide anchor points either for a rope-based rapid egress operation or as a tether point for search and rescue efforts in confined and smoke-filled spaces. To install and place the utility anchor 10 between a hinge stile 80 and a door jamb 82, the user simply pushes the eye portion 40 of rod 36 so that stopper 44 is spaced apart from anchor body 12 and such that pin(s) 44 rests on shoulders 68, preferably in opposing detents or recesses 66 in the shoulders 68 so as to prevent inadvertent rotation. FIG. 3A. The stopper 46 is inserted through the space between the hinge stile and the jamb, and the top 14 or top portion of the anchor body 12 is wedged between the door stile and jamb. FIG. 3B. The rod is then rotated until the longitudinal axis of the stopper element 46 is generally aligned with the longitudinal axis 70 of the anchor body 12, and pins 66 are allowed to nest into opposing channels or recesses 60 cut alongside the upper portion of the through hole 34. The anchor 10 is effectively locked in this “aligned” and retracted configuration or position. A carabiner 84 to which a rope 86 is connected can be clipped to eye 40 for use as a rope tether, change-of-direction anchor, or rapid egress anchor point.

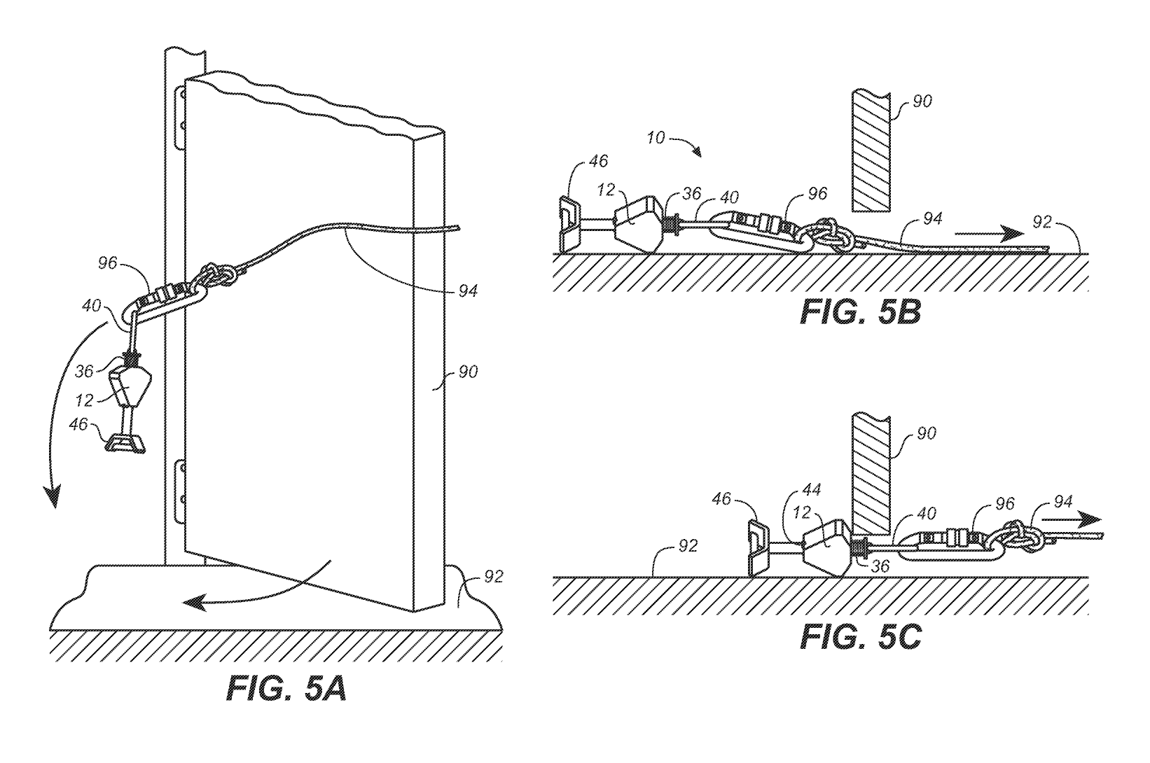

Referring next to FIGS. 5A through 5C, there is shown a second technique for using a door as an anchoring element for the inventive firefighter's utility anchor. In this instance, the anchor 10 is placed behind a door 90 with the stopper rod 36 and eye portion 40 disposed through the space between the bottom of the door 90 and the floor 92. The anchor is first attached to a rope 94 connected to a carabiner 96. It is then placed underneath and against a door, typically by opening the door and throwing or placing the anchor on the side of the door opposite that of the direction the user will be traveling. The rope is attached to the eye portion 40, which is close to contact with the ground. The door is then closed with the anchor on the side opposite the user. The longitudinal axis of the stopper 46 is thus configured in a cross (or non-aligned) configuration relative to the longitudinal axis 70 of the anchor body 12, and the apparatus is placed in an extended configuration, wherein “extended” refers to the fact that the stopper is extended apart and away from the top 14 of the anchor body 12. Then, as tension is put on the rope, the anchor pulls snugly against the door to provide an anchor point for a bail out procedure, as a tether for search operations, and as a direction finder when change-of-direction maneuvers are conducted within the structure.

From the foregoing it will be evident that the inventive utility anchor has two operative configurations (retracted and extended, corresponding to aligned and non-aligned) and can be deployed and used as an anchoring device in either configuration. That is, the apparatus works as an anchoring device either with the stopper and anchor longitudinal axes aligned or non-aligned, wherein the stopper is extended away from and separated from the anchor body in the non-aligned configuration with the pins resting on the top shoulders in recesses, and it is approximated to, or nearly so, in the aligned configuration, wherein the pins are nested within the anchor body in channels cut alongside the through hole.

From the foregoing, it will also be appreciated that in its most essential aspect, the present invention is a utility anchor having a retracted configuration and an extended configuration and that operates as a tether or anchor in either configuration. It includes an anchor body having a through hole, a rod slidably disposed in the through hole and having a first end and a second end, a rope connector disposed on the first end of the rod, a stopper disposed on the second end of the rod, and a locking element disposed on the rod. A spring disposed between the rope connector and the anchor body urges the apparatus into the retracted configuration, wherein the longitudinal axis the stopper and the anchor body are generally parallel and the locking element is disposed within the anchor body. When the anchor is in the extended configuration, the longitudinal axes of the stopper and the anchor body are not parallel and the stopper is separated from the anchor body.

What is claimed as invention is:

1. A utility anchor to anchor rope for rapid egress and building bailout operations and as a tether for search operations in enclosed spaces with reduced visibility, said utility anchor having a retracted configuration and an extended configuration, comprising:
an anchor body having a front side, a back side, a top side, a bottom side, right and left sides, and a through hole extending through said anchor body from said top side to said bottom side;
a rod slidably disposed in said through hole and having a first end and a second end;
a rope connector disposed on said first end of said rod;
a stopper disposed on said second end of said rod, said stopper having a width and a longitudinal axis;
a locking element disposed on said rod; and
a spring disposed between said rope connector and said bottom side of said anchor body;
wherein when said utility anchor is in the retracted configuration the longitudinal axis of each of said stopper and said anchor body are in a generally parallel alignment and said locking element is disposed within said anchor body, and when said utility anchor is in the extended configuration the longitudinal axis of said stopper and said anchor body are not parallel and said locking element is disposed on or proximate said top side of said anchor body.

2. A utility anchor, comprising:
an anchor body having front, back, top, and bottom sides, and a generally wedge shape when viewed from either of said front or back sides, said anchor body having a through hole disposed from said top side to said bottom side and opposing channels extending down a portion of said through hole;
a rod slidably disposed in said through hole, said rod having a connection element disposed at a first end, a stopper disposed on a second end, said stopper including an elongate bar having a longitudinal axis and having a width substantially the same as the width of said anchor body;
opposing pins disposed on said rod below and spaced apart from said stopper; and
a helical compression spring disposed around a portion of said rod shaft immediately above and between said lower collar and said bottom side of said anchor body, thereby making said rod spring-loaded relative to said anchor body, such that said spring urges said first end of said rod downwardly and away from said anchor body and urges said stopper toward said anchor body;
wherein said pins rest on said shoulders of said anchor body when said rod is pushed sufficiently upwardly and turned such that said longitudinal axis of said stopper is generally normal to said longitudinal axis of said anchor body, and wherein when said longitudinal axis of said stopper is substantially parallel to said longitudinal axis of said anchor body, said rod is urged outwardly by said spring from said bottom side of said anchor body, and said pin nests in said channels.

3. A utility anchor having an extended and a retracted configuration, comprising:
a generally solid anchor body having a through hole;
a shaft slidably and rotatably disposed in said through hole;
a stopper element disposed on a first end of said shaft and a connector element disposed on a second end of said shaft;
a bias member disposed between said anchor body and said connector element urging said connector element away from said anchor body such that the utility anchor is in a retracted configuration; and
locking structure disposed on said shaft for selectively locking said utility anchor into an extended configuration;
wherein by pushing said connector element toward said anchor body and turning said shaft within said through hole, said utility anchor can be moved from a retracted configuration to an extending configuration.
